(19) United States
(12) Patent Application Publication
(10) Pub. No.: US 2026/0161389 A1
(43) Pub. Date: Jun. 11, 2026

(54) EMBEDDED SBOM REPORT AND UPDATE OF THE SAME BUILD ORCHESTRATION

(71) Applicant: American Megatrends International, LLC, Duluth (GA)

(72) Inventors: Chitrak Gupta, Johns Creek, GA (US); Adonay Berthe, Duluth, GA (US)

(21) Appl. No.: 18/973,404

(22) Filed: Dec. 9, 2024

(51) Int. Cl. G06F 8/73

(52) U.S. Cl. CPC G06F 8/73

(57) ABSTRACT

In an aspect of the disclosure, a method, a computer-readable medium, and an apparatus are provided. The apparatus may include one or more computing devices. The one or more computing devices generates a plurality of firmware images including at least a baseboard management controller (BMC) firmware image. The one or more computing devices generate a software bill of materials (SBOM) report for each of the plurality of firmware images. The one or more computing devices store the SBOM reports in an SBOM cache. The one or more computing devices retrieve the SBOM reports from the SBOM cache. The one or more computing devices package the SBOM reports with the BMC firmware image. The one or more computing devices store the packaged SBOM reports in a BMC flash memory.

### BACKGROUND

### Field

The present disclosure relates generally to computing systems, and more particularly, to techniques of generating and updating software bill of materials (SBOM) reports of firmware images.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

Software and firmware supply chain security had become increasingly critical due to the rise in cyber attacks and vulnerabilities. Traditional approaches to firmware management in server environments, particularly in data centers, lacked comprehensive mechanisms for tracking and verifying the components that made up firmware images. While hardware components had well-established bill of materials practices, firmware and software components did not have standardized methods for documenting and tracking their constituent parts.

Baseboard Management Controllers (BMCs) served as out-of-band management entities on servers, providing remote monitoring and management capabilities through standards like IPMI and Redfish. These BMCs contained firmware composed of numerous components, including proprietary code, open-source software, and third-party contributions. However, there was no standardized way to document and track these components as they moved through the supply chain from firmware providers to Original Design Manufacturers (ODMs) to end customers.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include one or more computing devices. The one or more computing devices generates a plurality of firmware images including at least a baseboard management controller (BMC) firmware image. The one or more computing devices generate a software bill of materials (SBOM) report for each of the plurality of firmware images. The one or more computing devices store the SBOM reports in an SBOM cache. The one or more computing devices retrieve the SBOM reports from the SBOM cache. The one or more computing devices package the SBOM reports with the BMC firmware image. The one or more computing devices store the packaged SBOM reports in a BMC flash memory.

In another aspect, the one or more computing devices generate a baseboard management controller (BMC) firmware image. The one or more computing devices retrieve one or more software bill of materials (SBOM) reports embedded within at least one of a boot firmware image and a platform root of trust (PROT) firmware image. The one or more computing devices synchronize the retrieved one or more SBOM reports with an SBOM report repository in the BMC firmware image. The one or more computing devices validate integrity of the synchronized one or more SBOM reports. The one or more computing devices store the validated one or more SBOM reports in a BMC flash memory.

In yet another aspect, the one or more computing devices receive a request to modify one or more firmware components associated with a baseboard management controller (BMC). The one or more computing devices retrieve an existing software bill of materials (SBOM) report from a cache of the BMC. The one or more computing devices update the existing SBOM report based on modifications to the one or more firmware components. The one or more computing devices transmit the updated SBOM report to the BMC for storage in the cache of the BMC.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller and a host computer.

FIG. 2 is a diagram illustrating a system for generating, collecting, and integrating Software Bill of Materials reports into a BMC firmware image.

FIG. 3 is a diagram illustrating a system for synchronizing and managing Software Bill of Materials reports across different firmware components within a server platform when firmware components are built separately.

FIG. 4 is a diagram illustrating a dynamic SBOM update system for managing firmware components in a distributed environment.

FIG. 5 is a flow chart of a first method for generating software bill of materials reports of firmware images.

FIG. 6 is a flow chart of a second method for generating software bill of materials reports of firmware images.

FIG. 7 is a flow chart of a method for updating software bill of materials reports of firmware images.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

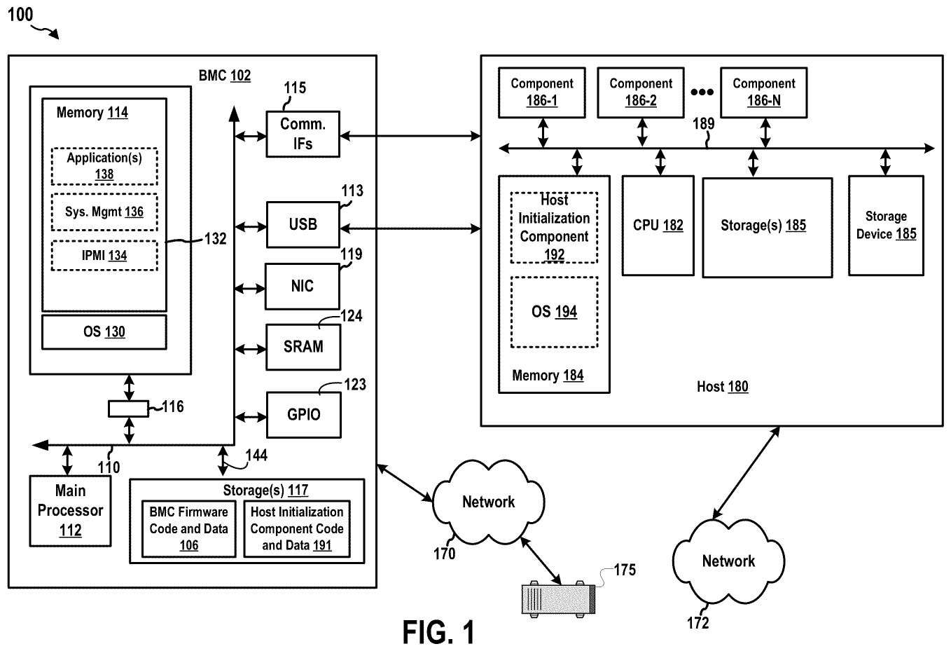

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

A software/firmware bill of materials (SBOM) is a comprehensive inventory that enumerates all the components, libraries, tools, utilities, and build environment details used to construct a software artifact. In embedded systems and firmware, such as those in the computer system 100 illustrated in FIG. 1, the SBOM enhances transparency, traceability, and security of firmware components.

The necessity for SBOMs has become increasingly significant due to the rise in software vulnerabilities, supply chain attacks, and on-the-fly tampering of software components. Recent mandates by governmental agencies require that software deliveries, especially to defense organizations, include an SBOM. This requirement extends to firmware components in devices like the baseboard management controller (BMC) 102 and the host computer 180, where firmware is not solely composed of proprietary code from the firmware provider but also incorporates open-source components and third-party contributions.

For instance, the BMC firmware code and data 106 stored in the storage(s) 117 may include hundreds of software packages that collectively form the final firmware image. These packages may contain code developed by the firmware provider, open-source code such as the Linux kernel from the Linux Foundation, and code from other third-party suppliers. Each of these components brings its own licenses, dependencies, and potential vulnerabilities.

The SBOM documents each component used in the firmware, including details such as the component name, version, supplier, and cryptographic hash values. The cryptographic hashes enable verification of component integrity, ensuring that the components have not been tampered with. Additionally, the SBOM outlines the dependencies between components, providing a clear map of how each piece of software interacts within the firmware. This level of detail is essential for identifying and addressing vulnerabilities that may arise in any of the components.

However, a firmware provider faces significant challenges in managing SBOMs across the firmware supply chain. The firmware provider is obligated to present SBOM reports with each firmware release or derivative work delivered to binary customers. Additionally, the firmware provider must provide the necessary tooling for source customers to generate SBOM reports as part of their derivative work deliverables to end-customers.

In the computer system 100, the BMC 102 and the host computer 180 rely on firmware that includes numerous components from various sources. When the firmware provider licenses source code to an Original Design Manufacturer (ODM), the ODM may make customizations and additions before building the firmware component and delivering the derivative work to the end customer. This creates a scenario where servers in a datacenter might run different firmware versions, making it difficult to track component origins and modifications.

One challenge is the transparency and traceability of firmware components through the supply chain. For example, if a vulnerability is discovered in a commonly used open-source component such as OpenSSL, datacenter operators and Cloud Service Providers (CSPs) lack the ability to quickly assess the impact of such vulnerabilities across their server fleet. They cannot readily determine which systems are affected or verify if patches have been applied by their ODMs. Without an efficient SBOM management mechanism, there is no quick way to perform impact analysis on firmware components because the end customer receives firmware in the form of binary blobs that provide no insight into their composition.

Moreover, there is a lack of efficient SBOM document management mechanisms for both points of manufacturing (ODMs/OEMs) and points of use (datacenters, CSPs, enterprise end-users). The absence of an efficient SBOM update mechanism with firmware configuration or component changes exacerbates the problem. When components within the BMC firmware code and data 106 are modified or updated, the corresponding SBOM must be updated to maintain accuracy. This requires a mechanism for updating SBOM documentation that can keep pace with firmware changes while maintaining the integrity of the supply chain documentation.

Additionally, there is a lack of tools for SBOM extraction from running systems, particularly across datacenters or Internet of Things (IoT) clusters. Existing third-party tools for generating binary SBOMs have limitations when applied to firmware applications. These tools often lack the capability to handle the intricacies of firmware environments, such as the embedded nature of firmware and the variety of components involved.

These challenges are particularly relevant for the computer system 100, where the BMC 102 manages critical system components and the host computer 180. The need for comprehensive SBOM management extends to all firmware components, including those in the storage(s) 117 and those controlling the component devices 186-1 to 186-N. Without proper SBOM management, the security and maintainability of these systems become increasingly difficult to maintain.

To address these challenges, the firmware provider's cloud platform offers a build orchestration service that generates downloadable SBOMs as part of the build flow for BIOS, BMC, and Platform Root of Trust (PROT) firmware solutions. This service can be extended to manage SBOMs for other firmware components. By integrating SBOM generation into the build process, the firmware provider aims to enhance transparency and traceability across the firmware supply chain.

However, even with the cloud platform's build orchestration service, the distribution of SBOM reports is not standardized, and there is no programmatic way of accessing or managing these reports within the firmware. For example, currently, SBOMs may be distributed via emails or through portal downloads, which is not efficient or secure. Embedding the SBOMs within the firmware images, such as the BMC firmware code and data 106, could provide a solution by allowing the reports to be accessed directly from the firmware.

The firmware provider's cloud platform addresses significant challenges in firmware management across multiple firmware types, including boot/BIOS firmware, BMC firmware code and data 106, and Hardware Root of Trust (HROT) or Platform Root of Trust (PROT) firmware. This comprehensive approach is particularly relevant for server platforms equipped with a BMC 102, where the management and tracking of firmware components become increasingly complex due to the inclusion of various software components from diverse sources.

The firmware types under consideration include boot/BIOS firmware, BMC firmware, and HROT/PROT firmware. The boot/BIOS firmware, such as the initialization component 192 stored in the host initialization component code and data 191, is responsible for initializing the host computer 180 during startup. The BMC firmware code and data 106 governs the operation of the BMC 102, which functions as an out-of-band management entity. The HROT/PROT firmware provides security features foundational to the trustworthiness of the system.

These firmware types are used in server platforms, especially those that include a BMC 102. The BMC 102, equipped with a main processor 112, memory 114, storage(s) 117, network interface card 119, and communication interfaces 115, manages and monitors server vitals such as temperature and voltage levels. It facilitates administrators to remotely access and manage the host computer 180 through standards like the Intelligent Platform Management Interface (IPMI) and Redfish.

The firmware provider's cloud platform offers a Build Orchestration Service (BOS), which creates and builds dynamic firmware images based on user configurations. This service supports various firmware types (BIOS, BMC, PROT, and others) and accommodates multiple host silicon options, such as Intel, AMD, Ampere, and NVIDIA processors.

The BOS provides customers with the ability to specify firmware types, including BIOS, BMC, PROT, and others; select host silicon options such as Intel, AMD, Ampere, NVIDIA, among others; and include build-time services such as image signing, automated testing, and SBOM generation.

The BOS can generate and manage SBOMs for all firmware components, including those controlling the component devices 186-1 to 186-N in the host computer 180.

The service components 132 of the BMC 102 may implement the SBOM management features. These components, operating through the BMC OS 130, facilitate the interaction between the cloud platform BOS and the firmware components, enabling real-time updates and management of SBOM information.

Through the communication network 170, which operates out-of-band to the data network 172 and the host computer 180, the BMC 102 can securely communicate with the cloud platform BOS. This separation of management traffic from regular data traffic enhances the security and reliability of SBOM management operations. The remote device 175 can interact with the BMC 102 through this network, enabling administrators to access and manage SBOM information without interfacing with the host OS 194.

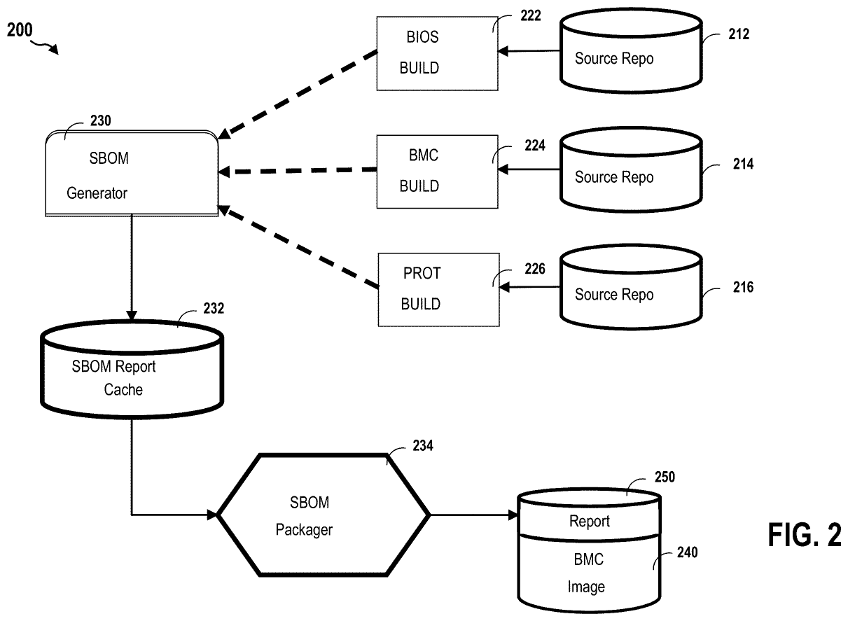

FIG. 2 is a diagram 200 illustrating a system for generating, collecting, and integrating Software Bill of Materials (SBOM) reports into firmware images, specifically within a BMC firmware image. This system manages SBOMs across multiple firmware components, including the BIOS, BMC, and PROT firmware.

In this example, the system includes three source code repositories: repository 212, repository 214, and repository 216. Each repository contains source code for a different firmware component. The source code repository 212 provides source code for a BIOS build 222, the source code repository 214 provides source code for a BMC build 224, and the source code repository 216 provides source code for a PROT build 226. These builds represent the compilation and assembly processes for their respective firmware components. The system also includes a SBROM generator 230, a SBOM report cache 232, and a SBOM packager 234. Each component in the system may be implemented by a computing device that has a structure similar to the structure of the host computer 180.

A central SBOM generator 230 interfaces with the BIOS build 222, the BMC build 224, and the PROT build 226 to analyze the components, dependencies, and metadata of each firmware build. A SBOM generator 230 creates standardized SBOM reports for each firmware image, using formats such as Software Package Data Exchange (SPDX) or CycloneDX. These SBOM reports comprehensively document the inventory of software components used in each firmware image, including component names, versions, suppliers, cryptographic hash values, licenses, and dependencies.

The generated SBOM reports are stored in an SBOM report cache 232, which serves as a centralized repository for the reports before their integration into the final BMC firmware image. The SBOM report cache 232 maintains the association between specific firmware builds and their corresponding SBOM reports, enabling efficient retrieval and management of SBOM information.

An SBOM packager 234 retrieves the SBOM reports from the SBOM report cache 232 and packages them together with the BMC image 240. The SBOM packager 234 integrates the SBOM reports for all firmware components-including the BIOS, BMC, and PROT firmware-into the BMC image 240. The BMC image 240 includes a dedicated section or partition for the SBOM report 250, which contains the consolidated SBOM information for all firmware components. By embedding the SBOM reports within the BMC firmware image, the system creates a direct and secure association between the firmware and its component documentation.

The BMC image 240, now containing the embedded SBOM report 250, is then deployed to the target hardware as the BMC firmware code and data 106. The BMC firmware code and data 106 stored in the storage(s) 117 (as described in FIG. 1) now includes the SBOM report 250, which can be accessed and managed directly from the BMC 102. This integration allows for consistent delivery of SBOM information alongside the firmware, facilitating easier management and access by end-users.

Traditionally, SBOM reports have been distributed through manual processes such as email or portal downloads, which are inefficient and can lead to discrepancies between the firmware and its associated SBOM. By embedding the SBOM report 250 within the BMC image 240, the system eliminates the need for separate distribution mechanisms. The embedded SBOM can be accessed programmatically through an OEM-specific Redfish API, for example, /redfish/v1/Manager/OEMGetSBOMReports(type), where type specifies the firmware component (e.g., BIOS, BMC, PROT). This allows clients and automated tools to retrieve SBOM information directly from the BMC firmware, enhancing transparency and traceability in the supply chain.

Furthermore, the SBOM reports are stored in a read/write partition in the BMC flash memory (e.g., within the root file system). This enables runtime updates to the SBOM information when firmware components are modified or updated. Security features such as SBOM report attestation, validation, and encryption can be implemented for added security. For example, the SBOM reports can be stored in an encrypted partition or have their access restricted, maintaining the integrity and confidentiality of the supply chain documentation.

In cases where firmware components are built separately rather than together, such as when only the BMC firmware is built and the BIOS and PROT firmware are provided independently, the BMC can retrieve SBOM reports for the BIOS and PROT firmware from their respective images or from an external repository upon being flashed and rebooted. The BMC would then update its SBOM report cache 232 to include the SBOM information for these components. As such, the embedded SBOM report 250 remains comprehensive and up to date.

The cloud platform's BOS is used to build the firmware images and generate the SBOM reports. When the BMC image 240 is built, the SBOM packager 234 on the cloud platform packages all the SBOM reports for the firmware components and integrates them into the BMC image 240. The cloud platform thereby facilitates the generation, management, and distribution of SBOM reports within the firmware supply chain.

By providing a standardized method for managing and distributing SBOM reports throughout the firmware supply chain, the system enhances transparency and traceability of firmware components. Original Design Manufacturers (ODMs) and Original Equipment Manufacturers (OEMs) can use the cloud platform to generate and update SBOM reports during the build process. When modifications are made to firmware components, the SBOM reports can be updated accordingly and embedded into the BMC image 240. End users, such as datacenter operators, can access this information through the BMC's Redfish interface, enabling rapid assessment of firmware components, identification of potential vulnerabilities, and efficient impact analysis when new vulnerabilities are discovered.

Below is an example of the SBOM report 250.

```
{
  “bomFormat”: “CycloneDX”,
  “specVersion”: “1.5”,
  “serialNumber”: “urn:uuid:16d82851-7112-11ef-9067-9cb6d0c8457a”,
  “version”: 1
  “metadata”: {
    “timestamp”: “2024-09-12T10:19:57-04:00”,
    “tools”: [
      {
        “vendor”: “firmware provider”,
        “name”: firmware provider UEFI SBOM Creator”,
        “version”: “2.1”
      }
    ],
    “supplier”: {
      “name”: “firmware provider”
    },
    “licenses”: [
      {
        “license”: {
          “name”: “firmware provider”
        }
      }
    ],
    “component”: {
      “type”: “firmware”,
```

| | |
|---|---|
| “bom-ref”: | “ExampleProject.A63A51A2-431B-46C2-988D- |

```
4EB7EC0B2014”,
      “supplier”: “firmware provider”,
      “name”: “ExampleProject”,
      “version”: “5.32_9AACA_RC0D.00.BD.40(4334.81)_011”,
      “licenses”: [
        {
          “license”: {
            “name”: “firmware provider”
          }
        }
      ],
      “components”: [
        {
          “type”: “firmware”,
          “bom-ref”: “brotli.f4153a0”,
          “name”: “brotli.f4153a0”,
          “version”: “f4153a0”,
          “licenses”: [
            {
              “license”: {
                “id”: “MIT”
              }
            }
          ],
          “externalReferences”: [
            {
              “url”: “https://github.com/google/brotli”,
              “type”: “website”
            }
          ],
          “pedigree”: {
            “notes”:  “Only  the  following  files  are
used:\nc/common\nc/dec\nc/include”
          }
        },
        {
          “type”: “firmware”,
          “bom-ref”: “ConvertUTF Unicode.Not provided by the supplier”,
          “name”: “ConvertUTF Unicode.Not provided by the supplier”,
          “version”: “Not provided by the supplier”,
          “licenses”: [
            {
              “license”: {
                “id”: “MIT”
              }
            }
          ]
        },
        {
          “type”: “firmware”,
```

| | |
|---|---|
| “bom-ref”: | “edk2- |

platforms.4c3e742e93158a1ee6cb3b571b1281e7fba2564”,

| | |
|---|---|
| “name”: | “edk2- |

```
platforms.4c3e742e93158a1ee6cb3b571b1281e7fba2564”,
          “version”: “4c3e742e93153a1ee6cb3b571b1281e7fba2564”,
          “licenses”: [
            {
              “license”: {
                “id”: “BSD-2-Clause-patent”
              }
            }
          ],
          “pedigree”: {
            “notes”:  “Only  the  following  files  are
used:\nFeatures/silicon/Debugging/*\nFeatures/silicon/OutOfBandManagement/*\n
Features/silicon/PowerManagement/*\nPlatform/silicon/BoardModulePkg/*\nPlatfo
rm/silicon/MinPlatformPkg/*\nSilicon/siliconSiliconPkg/*”
          }
        },
        {
          “type”: “firmware”,
          “bom-ref”: “libfdt.cfff805”,
          “name”: “libfdt.cfff805”,
          “version”: “cfff805”,
          “licenses”: [
            {
              “license”: {
                “id”: “BSD-2-Clause”
              }
            }
          ],
          “externalReferences”: [
            {
              “url”: “https://github.com/devicetree-org/pylibfdt”,
              “type”: “website”
            }
          ],
          “pedigree”: {
            “notes”: “Only the following files are used:\nlibfdt/*”
          }
        },
        {
          “type”: “firmware”,
          “bom-ref”: “LibTomCrypt.1.17”,
          “name”: “LibTomCrypt.1.17”,
          “version”: “1.17”,
          “licenses”: [
            {
              “license”: {
                “id”: “Unlicense”
              }
            }
          ],
          “externalReferences”: [
            {
              “url: “https://github.com/libtom/libtomcrypt”,
              “type”: “website”
            }
          ],
          “pedigree”: {
            “notes”:  “Only  the  following  files  are
used:\nsrc/hashes/sha2/sha384.c\nsrc/hashes/sha2/sha512.c\nsrc/pk/pkcs1/pkcs_1_v
1_5_decode.c\nsrc/pk/pkcs1/pkcs_1_pss_decode.c”
          }
        },
        {
          “type”: “firmware”,
          “bom-ref” “mipisyst.v1.1+edk2”,
          “name”: “mipisyst.v1.1+edk2”,
          “version”: “v1.1+edk2”,
          “licenses”:[
            {
              “license”: {
                “id”: “BSD-3-Clause”
              }
            }
          ],
          “externalReferences”: [
            {
              “url”: “https://github.com/MIPI-Alliance/public-mipi-sys-t”,
              “type”: “website”
            }
          ],
          “pedigree”: {
            “notes”:  “Only  the  following  files  are
used:\nlibrary/src/*\nlibrary/include/mipi_syst/*”
          }
        }
      ]
    }
  },
  “dependencies”: [
    {
      “ref”: “ExampleProject.A63A51A2-431B-46C2-988D-4EB7EC0B2014”,
      “dependsOn”: [
        “brotli.f4153a0”,
        “ConvertUTF Unicode.Not provided by the supplier”,
        “edk2-platforms.4c3e742e931538a1ee6cb3b571b1281e7fba2564”,
        “libfdt.cfff805”,
        “LibTomCrypt.1.17”,
        “mipisyst.v1.1+edk2”
      ]
    },
    {
      “ref”: “brotli.f4153a0”,
      “dependsOn”: [ ]
    },
    {
      “ref”: “ConvertUTF Unicode. Not provided by the supplier”,
      “dependsOn”: [ ]
    },
    {
      “ref”: “edk2-platforms.4c3e742e931538a1ee6cb3b571b1281e7fba2564”,
      “dependsOn”: [ ]
    },
    {
      “ref”: “libfdt.cfff805”,
      “dependsOn”: [ ]
    },
    {
      “ref”: “LibTomCrypt.1.17”,
      “dependsOn”: [ ]
    },
    {
      “ref”: “mipisyst.v1.1+edk2”,
      “dependsOn”: [ ]
    }
  ]
}
```

The SBOM report 250 is a comprehensive software bill of materials structured in the CycloneDX format, version 1.5. The report begins with essential metadata including a unique serial number (UUID) and version information. Another element is the timestamp, which establishes a temporal link between the SBOM and its corresponding firmware build, enabling precise version tracking and correlation.

The report identifies the tool used for generation—in this case, a UEFI SBOM Creator version 2.1 from the firmware provider. Each component within the SBOM receives a unique reference identifier, such as “A63A51A2-431B-46C2-988D-4EB7EC0B2014”, which serves as an immutable reference point throughout the supply chain. This identifier is used when tracking modifications or establishing component provenance.

The SBOM generator 230 creates detailed entries for each software component, including proprietary elements from the firmware provider, Intel, NVIDIA, and other silicon vendors. Each entry contains critical information: the component name, version, applicable licenses, and external references. For instance, the component “brotli.f4153a0” includes its MIT license designation and a direct URL to its GitHub repository, facilitating immediate access to the source code and documentation.

The SBOM packager 234 incorporates a sophisticated dependency mapping system within the SBOM report 250. This mapping creates a relationship table that documents inter-component dependencies, enabling rapid impact assessment when vulnerabilities are discovered. For example, if a vulnerability is identified in a fundamental component like OpenSSL, the dependency chart immediately reveals all dependent components requiring patches or updates.

The granular documentation extends to specific file usage within components. For example, the LibTomCrypt component entry specifies exactly which source files are utilized: “src/hashes/sha2/sha384.c”, “src/hashes/sha2/sha512.c”, and others. This level of detail supports precise vulnerability tracking and patch management.

When integrated into the BMC image 240, this SBOM structure provides a robust mechanism for supply chain verification. If an Original Design Manufacturer (ODM) modifies the source code and encounters vulnerabilities, the SBOM's component hashes and dependency mappings can definitively establish whether the vulnerability originated in the original distribution or was introduced through subsequent modifications.

The SBOM report 250 also facilitates dynamic update management through the cloud platform's Build Orchestration Service. When new components are added or existing ones are modified, the SBOM generator 230 updates the report, maintaining an accurate representation of the firmware's composition. This dynamic nature supports real-time vulnerability assessment and patch planning across distributed systems.

The relationship between components is explicitly documented in the dependencies section, where each component's “dependsOn” array lists its dependencies. This structure enables the creation of comprehensive dependency graphs, supporting both security analysis and update planning. For instance, the main project component “ExampleProject” lists dependencies on multiple components including “brotli.f4153a0” and “LibTomCrypt.1.17”, creating a clear map of the software's architecture and potential vulnerability paths.

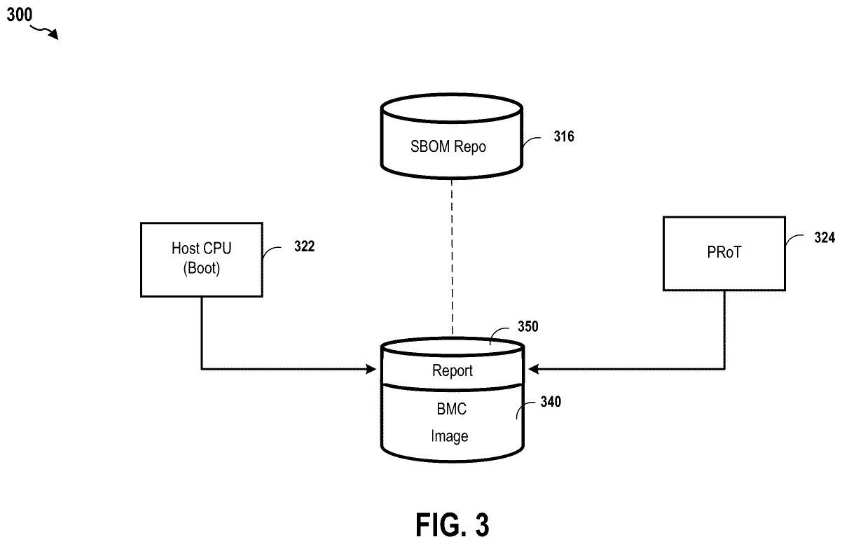

FIG. 3 is a diagram 300 illustrating a system for synchronizing and managing Software Bill of Materials (SBOM) reports across different firmware components within a server platform when the firmware components are built separately. Each component in the system may be implemented by a computing device that has a structure similar to the structure of the host computer 180. In this configuration, the firmware components for the BIOS, the BMC, and the PROT are generated independently through different build pipelines and delivery cycles.

The diagram 300 shows an SBOM repository 316, a host CPU 322, a PROT 324, and a BMC image 340 containing an integrated SBOM report 350. The SBOM repository 316 serves as a centralized storage location for SBOM reports generated during the firmware build processes. This repository maintains master copies of SBOM reports for various firmware components, enabling version control and historical tracking of component changes throughout the supply chain.

In this scenario, the host CPU 322 represents the boot firmware component of the host computer 180, which includes its own embedded SBOM report generated during its independent build process. Similarly, the PROT 324 represents the firmware component for the Platform Root of Trust, which also contains an embedded SBOM report generated during its separate build process. These components operate independently but are integral to the overall system firmware architecture.

The BMC image 340 functions as a central consolidation point for SBOM reports from different firmware components. The BMC image 340 includes a dedicated SBOM report 350 section that stores and manages SBOM information from multiple sources. When the BMC image 340 is built using the cloud platform's BOS, it is initially created with its own SBOM information. However, since the boot and PROT firmware components are built separately, the BMC image 340 needs to synchronize and consolidate the SBOM reports from these components to maintain a comprehensive view of the system's firmware composition.

Upon flashing the new BMC image 340 and rebooting the system, the BMC 102 initiates a synchronization process to pull SBOM reports from both the host CPU 322 and the PROT 324. This process involves the BMC 102 accessing the embedded SBOM reports within the boot and PROT firmware images using appropriate communication interfaces, such as the communication channel 110 or other suitable inter-component communication mechanisms. The BMC 102 retrieves the SBOM reports and updates its SBOM report repository within the SBOM report 350.

The BMC 102 then performs validation checks by comparing its internal SBOM report repository with the SBOM information retrieved from the host CPU 322 and the PROT 324. This verification process helps maintain the integrity and consistency of SBOM information across the system. If discrepancies are detected, appropriate actions can be taken, such as alerting administrators or initiating remediation processes. Additionally, SBOM report attestation, validation, and encryption can be performed to enhance security. For example, the SBOM reports can be signed and encrypted to prevent tampering and unauthorized access.

The integration of SBOM reports into the BMC image 340 provides a common Application Programming Interface (API)-driven space for consolidating all SBOM reports, which can be accessed by customers and automated tools through standardized interfaces. In particular, the BMC 102 can provide an OEM-specific Redfish API, such as/redfish/v1/Manager/OEMGetSBOMReports (type), where type specifies the firmware component (e.g., BIOS, BMC, PROT). This API allows clients to retrieve SBOM information directly from the BMC firmware, facilitating transparency and traceability in the supply chain.

The system's design supports scalability and flexibility, accommodating future expansion into other firmware delivery areas beyond BIOS, BMC, and PROT. For instance, as the firmware provider plans to expand to other firmware components such as immersion cooling racks, rack management systems, Graphics Processing Units (GPUs), and storage devices, this architecture allows for the collection and consolidation of SBOM reports from each vendor involved. The BMC image 340 serves as a centralized repository where all SBOM reports can be accessed conveniently by customers, aiding in comprehensive supply chain management.

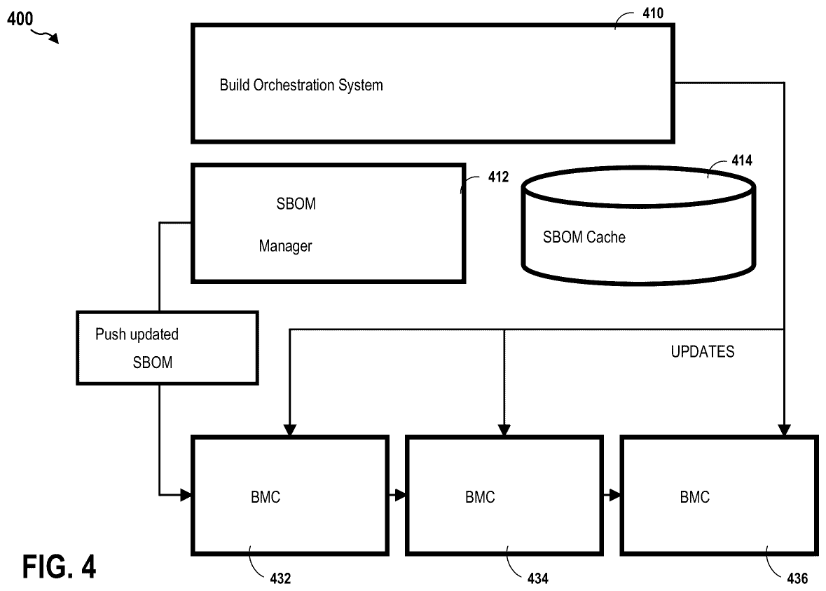

FIG. 4 is a diagram 400 illustrating a dynamic SBOM update system for managing firmware components in a distributed environment, such as a data center where servers frequently undergo firmware modifications, updates, or replacements. The system includes a Build Orchestration System (BOS) 410, a SBOM manager 412, a SBOM cache 414, and multiple Baseboard Management Controllers (BMCs) 432, 434, and 436, each managing one or more server nodes within the data center. Each component in the system may be implemented by a computing device that has a structure similar to the structure of the host computer 180.

The BOS 410 serves as the central orchestration point for firmware builds and updates across the platform. When new firmware components are added or existing components are modified—whether by the firmware provider, an ODM, or an OEM—the BOS 410 initiates the SBOM update process to maintain the integrity of the supply chain documentation.

The SBOM manager 412 coordinates the SBOM update process by interfacing with both the BOS 410 and the SBOM cache 414. The SBOM cache 414 acts as a centralized repository that stores and manages SBOM reports, maintaining an aggregated view of all SBOMs across different builds and firmware components.

When a new component is injected into the system firmware, or when existing components are upgraded or removed, the SBOM associated with the firmware must be updated accordingly. The BOS 410 retrieves the existing SBOM report for the specific build from each BMC's SBOM cache using an OEM-specific Redfish API, such as/redfish/v1/Manager/OEMGetSBOMReports (type), where type specifies the firmware type (e.g., BMC, BIOS, or PROT).

In alternative implementations, the BOS 410 may retrieve the older SBOM report from a local cache or a cloud-based database, especially if the required SBOM information is not available on the BMC or if a consolidated view is needed. The cloud platform may provide access to stored SBOM reports for various platforms, allowing the BOS 410 to update the contents of the SBOM based on the latest firmware changes.

Once the BOS 410 has retrieved the existing SBOM report, it updates the SBOM entries to reflect any new components added or existing components modified. This includes updating component names, versions, cryptographic hash values, dependencies, and other relevant metadata. The updated SBOM entries may also reflect changes in the dependency mapping, indicating how new components interact with existing ones.

After updating the SBOM report, the BOS 410 pushes the updated SBOM back to the respective BMCs 432, 434, and 436. This is accomplished using another OEM-specific Redfish API, such as/redfish/v1/Manager/OEM_UpdateSBOM (type, file), where type specifies the firmware type and file contains the updated SBOM data. The BMCs then store the updated SBOM information in their local SBOM caches, which are part of their firmware images.

The BMCs 432, 434, and 436, each equipped with their own SBOM cache, represent a distributed network of server management controllers that manage firmware components for individual server nodes. By propagating the updated SBOM information to each BMC, the system maintains consistency in SBOM documentation across all nodes in the data center.

This dynamic SBOM update system addresses the challenge of maintaining accurate SBOM documentation in environments where firmware components are frequently updated or modified. It allows for the secure injection of new components and modules into the firmware at runtime, as well as the removal or upgrading of existing components, all while keeping the SBOM information current.

For example, when a customer's platform requires specific firmware builds—such as BIOS, BMC, HROT, and other platform firmware—the system consolidates all relevant SBOM information through the firmware management system. The consolidated SBOMs are stored in the BMC and delivered as part of the firmware package. Customers receive a BMC image containing all related firmware and their SBOM reports, which are created at the build orchestrator level.

Customers can utilize applications provided by the firmware provider, such as a Data Center Manager (DCM), or third-party security applications, to access the SBOM reports via the Redfish APIs. This enables them to retrieve SBOM information for each deployed node in the data center, providing a comprehensive view of the supply chain. They can track changes made by the firmware provider, ODMs, and other parties, and validate the integrity of firmware components as they move through different entities in the supply chain.

By correlating the SBOM reports stored in the BMCs with those stored in the cloud platform's build orchestrator, customers can verify whether any changes have occurred during the firmware's transition from one entity to another. This level of transparency allows for thorough validation at every stage, verifying that the firmware has not been tampered with and that all components are accounted for.

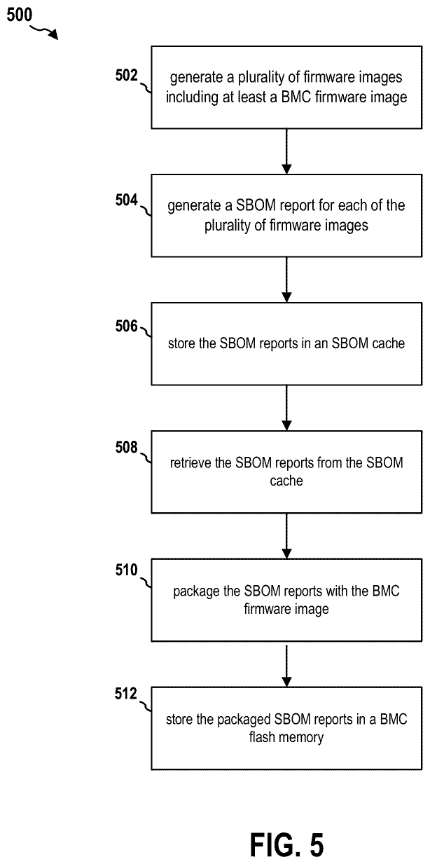

FIG. 5 is a flow chart 500 of a first method for managing software bill of materials (SBOM) reports in firmware images. The method may be performed by one or more computing devices (e.g., the SBOM generator 230, the SBOM packager 234, the BMC 102). In operation 502, the one or more computing devices generate a plurality of firmware images including at least a BMC firmware image. In operation 504, the one or more computing devices generate a SBOM report for each of the plurality of firmware images. In operation 506, the one or more computing devices store the SBOM reports in an SBOM cache. In operation 508, the one or more computing devices retrieve the SBOM reports from the SBOM cache. In operation 510, the one or more computing devices package the SBOM reports with the BMC firmware image. In operation 512, the one or more computing devices store the packaged SBOM reports in a read/write partition of a BMC flash memory.

In certain configurations, the plurality of firmware images further includes a basic input/output system (BIOS) firmware image and a platform root of trust (PROT) firmware image. In certain configurations, the one or more computing devices provide an application programming interface (API) to access the SBOM reports stored in the BMC flash memory.

In certain configurations, the one or more computing devices perform attestation of the SBOM reports stored in the BMC flash memory. In certain configurations, the one or more computing devices encrypt the SBOM reports stored in the BMC flash memory.

To generate the SBOM report, the one or more computing devices generate component information including component names, versions, and cryptographic hash values, generate dependency information between components, and format the component and dependency information according to a standardized SBOM format. In certain configurations, the standardized SBOM format comprises at least one of a Software Package Data Exchange (SPDX) format or a CycloneDX format.

In certain configurations, the one or more computing devices validate integrity of the stored SBOM reports using cryptographic hash values.

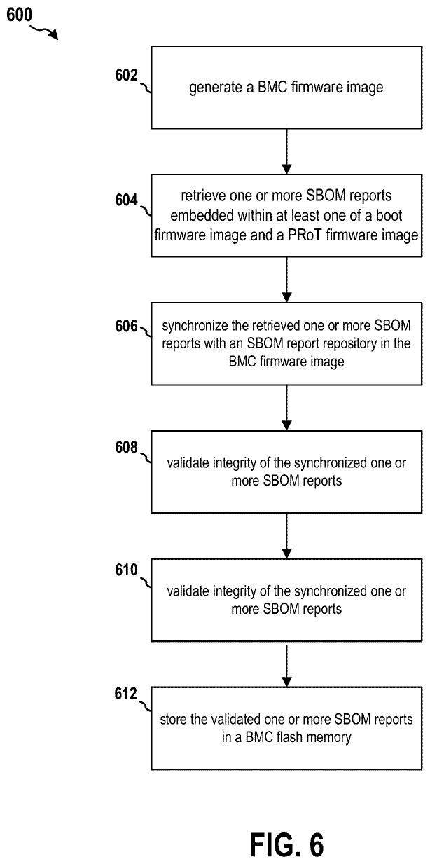

FIG. 6 is a flow chart 600 of a second method for managing software bill of materials (SBOM) reports in firmware images. The method may be performed by one or more computing devices (e.g., the SBOM generator 230, the SBOM packager 234, the BMC 102). In operation 602, the one or more computing devices generate a BMC firmware image. In operation 604, the one or more computing devices retrieve one or more SBOM reports embedded within at least one of a boot firmware image and a PROT firmware image. In operation 606, the one or more computing devices synchronize the retrieved one or more SBOM reports with an SBOM report repository in the BMC firmware image. In operation 608, the one or more computing devices validate integrity of the synchronized one or more SBOM reports. In operation 610, the one or more computing devices store the validated one or more SBOM reports in a BMC flash memory.

To retrieve the one or more SBOM reports, the one or more computing devices detect a system reboot after flashing the BMC firmware image and obtain the one or more SBOM reports from the boot firmware image and the PROT firmware image during the system reboot.

To validate integrity of the synchronized one or more SBOM reports, the one or more computing devices compare the synchronized one or more SBOM reports with existing SBOM reports in the BMC firmware image and verify cryptographic hash values associated with components listed in the one or more SBOM reports.

In certain configurations, the one or more computing devices encrypt the one or more SBOM reports stored in the BMC flash memory.

In certain configurations, the one or more computing devices provide an application programming interface (API) to access the one or more SBOM reports stored in the BMC flash memory.

In certain configurations, the one or more SBOM reports comprise component information including component names, versions, and cryptographic hash values, dependency information between components, and supplier information for each component.

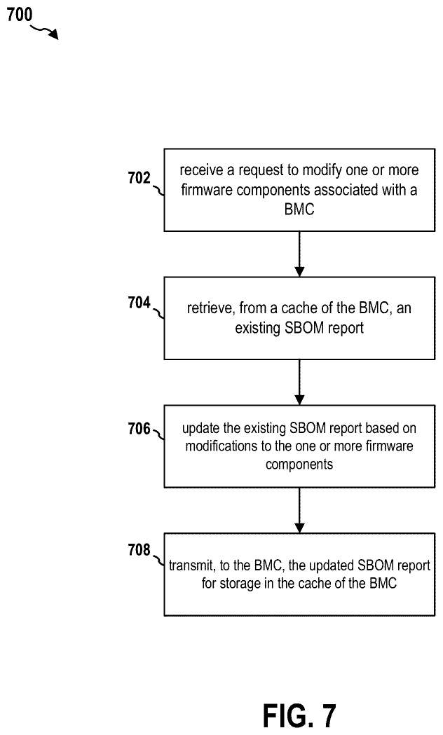

FIG. 7 is a flow chart 700 of a method for managing firmware components in a computing environment. The method may be performed by one or more computing devices (e.g., the build orchestrator system 410, the SBOM manager 412, the BMCs 432, 434, 436). In operation 702, the one or more computing devices receive a request to modify one or more firmware components associated with a BMC. In operation 704, the one or more computing devices retrieve, from a cache of the BMC, an existing SBOM report. In operation 706, the one or more computing devices update the existing SBOM report based on modifications to the one or more firmware components. In operation 708, the one or more computing devices transmit, to the BMC, the updated SBOM report for storage in the cache of the BMC.

To update the existing SBOM report, the one or more computing devices identify new components added to the one or more firmware components, generate SBOM entries for the new components, and add the SBOM entries to the existing SBOM report.

In certain configurations, the one or more computing devices update dependency mappings between firmware components in the SBOM report, update version information for modified firmware components, and update supplier information for the modified firmware components.

In certain configurations, the one or more computing devices encrypt the updated SBOM report before transmitting it to the BMC.

In certain configurations, the one or more computing devices validate integrity of the updated SBOM report using cryptographic hash values of the firmware components.

In certain configurations, the cache of the BMC is a local cache accessible to a build orchestrator system.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operation of one or more computing devices, comprising:
generating a plurality of firmware images including at least a baseboard management controller (BMC) firmware image;
generating a software bill of materials (SBOM) report for each of the plurality of firmware images;
storing the SBOM reports in an SBOM cache;
retrieving the SBOM reports from the SBOM cache;
packaging the SBOM reports with the BMC firmware image; and
storing the packaged SBOM reports in a BMC flash memory.

2. The method of claim 1, wherein the plurality of firmware images further includes a basic input/output system (BIOS) firmware image and a platform root of trust (PROT) firmware image.

3. The method of claim 1, further comprising:
providing an application programming interface (API) to access the SBOM reports stored in the BMC flash memory.

4. The method of claim 1, further comprising:
performing attestation of the SBOM reports stored in the BMC flash memory.

5. The method of claim 1, further comprising:
encrypting the SBOM reports stored in the BMC flash memory.

6. The method of claim 1, wherein generating the SBOM report comprises:
generating component information including component names, versions, and cryptographic hash values;
generating dependency information between components; and
formatting the component and dependency information according to a standardized SBOM format.

7. The method of claim 6, wherein the standardized SBOM format comprises at least one of a Software Package Data Exchange (SPDX) format or a CycloneDX format.

8. The method of claim 1, further comprising:
validating integrity of the stored SBOM reports using cryptographic hash values.

9. A method of operation of one or more computing devices, comprising:
generating a baseboard management controller (BMC) firmware image;
retrieving one or more software bill of materials (SBOM) reports embedded within at least one of a boot firmware image and a platform root of trust (PROT) firmware image;
synchronizing the retrieved one or more SBOM reports with an SBOM report repository in the BMC firmware image;
validating integrity of the synchronized one or more SBOM reports; and
storing the validated one or more SBOM reports in a BMC flash memory.

10. The method of claim 9, wherein retrieving the one or more SBOM reports comprises:
detecting a system reboot after flashing the BMC firmware image; and
obtaining the one or more SBOM reports from the boot firmware image and the PROT firmware image during the system reboot.

11. The method of claim 9, wherein validating integrity of the synchronized one or more SBOM reports comprises:
comparing the synchronized one or more SBOM reports with existing SBOM reports in the BMC firmware image; and
verifying cryptographic hash values associated with components listed in the one or more SBOM reports.

12. The method of claim 9, further comprising:
encrypting the one or more SBOM reports stored in the BMC flash memory.

13. The method of claim 9, further comprising:
providing an application programming interface (API) to access the one or more SBOM reports stored in the BMC flash memory.

14. The method of claim 9, wherein the one or more SBOM reports comprise:
component information including component names, versions, and cryptographic hash values;
dependency information between components; and
supplier information for each component.

15. A method of managing firmware components in a computing environment, the method comprising:
receiving a request to modify one or more firmware components associated with a baseboard management controller (BMC);
retrieving, from a cache of the BMC, an existing software bill of materials (SBOM) report;
updating the existing SBOM report based on modifications to the one or more firmware components; and
transmitting, to the BMC, the updated SBOM report for storage in the cache of the BMC.

16. The method of claim 15, wherein updating the existing SBOM report comprises:
identifying new components added to the one or more firmware components;
generating SBOM entries for the new components; and
adding the SBOM entries to the existing SBOM report.

17. The method of claim 15, further comprising:
updating dependency mappings between firmware components in the SBOM report;
updating version information for modified firmware components; and
updating supplier information for the modified firmware components.

18. The method of claim 15, further comprising encrypting the updated SBOM report before transmitting it to the BMC.

19. The method of claim 15, further comprising validating integrity of the updated SBOM report using cryptographic hash values of the firmware components.

20. The method of claim 15, wherein the cache of the BMC is a local cache accessible to a build orchestrator system.
